(19) United States
(12) Patent Application Publication
(10) Pub. No.: US 2013/0040727 A1
(43) Pub. Date: Feb. 14, 2013

(54) GAME MACHINE, METHOD OF CONTROLLING COMPUTER, AND STORAGE MEDIUM

(71) Applicant: Masaya MATSUDA, Zama-shi (JP)

(72) Inventor: Masaya MATSUDA, Zama-shi (JP)

(73) Assignee: KONAMI GAMING, INCORPORATED, Las Vegas, NV (US)

(21) Appl. No.: 13/567,759

(22) Filed: Aug. 6, 2012

(30) Foreign Application Priority Data
Aug. 11, 2011 (AU) 2011211372

(51) Int. Cl. A63F 13/00

(52) U.S. Cl. 463/21; 463/25; 463/20

(57) ABSTRACT

A gaming machine provides a game opportunity in which at least one prize winning can be generated, determines whether or not the prize winning is present in the game opportunity, and provides prize winning advantage when the prize winning is generated based on a result of determination. And the gaming machine determines whether or not a number of prize winnings in a predetermined range is equal to or more than a predetermined number of the prize winnings, and provides favorable condition when the number of the prize winnings is equal to or more than the predetermined number of the prize winnings.

### CROSS REFERENCE TO RELATED APPLICATION

This application claims priority to Australian Patent Application No. 2011211372, filed Aug. 11, 2011, the disclosure of which is hereby incorporated by reference in its entirety.

### TECHNICAL FIELD

The present invention relates to a gaming machine providing a game opportunity in which at least one prize winning can be generated.

### BACKGROUND ART

There is a game machine providing in exchange of consumption of a game value, a game opportunity that cells are defined so as to be arranged in a matrix of a predetermined number of rows and number of columns, and a prize winning is won when symbols positioned on each cell form a prize winning arrangement. As one of the game machines like this, there is known the game machine that a line used for determination of the prize winning increases with increasing predetermined number of the game value units which is consumed for the one game opportunity and probability of the prize winning rises (for example, refer to the Patent Document 1). Patent Document 1: U.S. Publication No. US2008/0096635.

### SUMMARY OF THE INVENTION

In the game machine of the Patent Document 1, the consumption of the game value is prompted since the probability of the prize winning increase. However, an advantage is merely provided according to each prize winning if the prize winning is won on the many lines by consuming the many game values. Accordingly, there is no motivation to prompt the consumption of the game value in the one game opportunity other than the increase of the probability of the prize winning. In contrast, it is possible to prompt the further consumption of the game value if it is possible to cause a motivation for a number of the lines on which the prize winnings are won, that is, to cause a motivation for a number of the prize winnings itself. In other words, there is room to use the number of the prize winnings for the motivation for the game opportunity.

An object of the present invention is to provide a gaming machine which is capable of using a number of prize winnings for a motivation for a game opportunity, and, to provide a control method and a computer program which are used in the gaming machine.

In order to solve the above problems, a gaming machine according to an aspect of the present invention is a gaming machine providing a game opportunity in which at least one prize winning can be generated, and the gamming machine includes: a prize winning determination device that determines whether or not the prize winning is present in the game opportunity; a prize winning advantage providing device that provides prize winning advantage when the prize winning is generated based on a result of determination by the prize winning determination device; a prize winning number determination device that determines whether or not a number of prize winnings in a predetermined range is equal to or more than a predetermined number of the prize winnings based on a result of the determination by the prize winning determination device; and a condition providing device that provides favorable condition when the number of the prize winnings is equal to or more than the predetermined number of the prize winnings based on a result of the determination by the prize winning number determination device.

According to the gaming machine of the present invention, if the number of the prize winnings in the predetermined range is equal to or more than the predetermined number of the prize winnings, the favorable condition is provided. Therefore, it is possible to use the number of the prize winnings for motivation to the game opportunity. As a result, for example, when the game opportunity is provided with consumption of a game value, it is possible to prompt an increase of consumed amount of the game value. And, it is possible to improve an interest of the game since an opportunity providing the favorable condition is also provided in addition to an opportunity of the prize winning.

In order to solve the above problems, a method of controlling a computer according to an aspect of the present invention includes the following steps, the computer being incorporated into a gaming machine providing a game opportunity in which at least one prize winning can be generated. The steps are: a prize winning determination step that determines whether or not the prize winning is present in the game opportunity; a prize winning advantage providing step that provides prize winning advantage when the prize winning is generated based on a result of determination by the prize winning determination step; a prize winning number determination step that determines whether or not a number of prize winnings in a predetermined range is equal to or more than a predetermined number of the prize winnings based on a result of the determination by the prize winning determination step; and a condition providing step that provides favorable condition when the number of the prize winnings is equal to or more than the predetermined number of the prize winnings based on a result of the determination by the prize winning number determination step.

In order to solve the above problems, a storage medium according to an aspect of the present invention stores a computer program for a gaming machine being configured to make a computer, which is incorporated into the gaming machine providing a game opportunity in which at least one prize winning can be generated, serve as: a prize winning determination device that determines whether or not the prize winning is present in the game opportunity; a prize winning advantage providing device that provides prize winning advantage when the prize winning is generated based on a result of determination by the prize winning determination device; a prize winning number determination device that determines whether or not a number of prize winnings in a predetermined range is equal to or more than a predetermined number of the prize winnings based on a result of the determination by the prize winning determination device; and a condition providing device that provides favorable condition when the number of the prize winnings is equal to or more than the predetermined number of the prize winnings based on a result of the determination by the prize winning number determination device.

### BRIEF DESCRIPTION OF THE DRAWINGS

FIG. 1 is an external view of a gaming machine according to an embodiment of the invention;

FIG. 2 is a pattern diagram illustrating an example of a game screen;

FIG. 3 is a functional block diagram of the gaming machine;

FIG. 4 is a diagram for describing prize winning determination lines;

FIG. 5 is a diagram illustrating an example of a flowchart of a slot game routine;

FIG. 6 is a diagram illustrating an example of a flowchart of a stop position lottery routine;

FIG. 7 is a diagram illustrating an example of a flowchart of a prize winning determination routine;

FIG. 8 is a diagram illustrating an example of a flowchart of a dividend providing routine;

FIG. 9 is a diagram illustrating an example of the lottery region that two symbols are displayed on the one cell; and

FIG. 10 is a diagram illustrating another example of the game screen.

### DESCRIPTION OF THE EMBODIMENTS

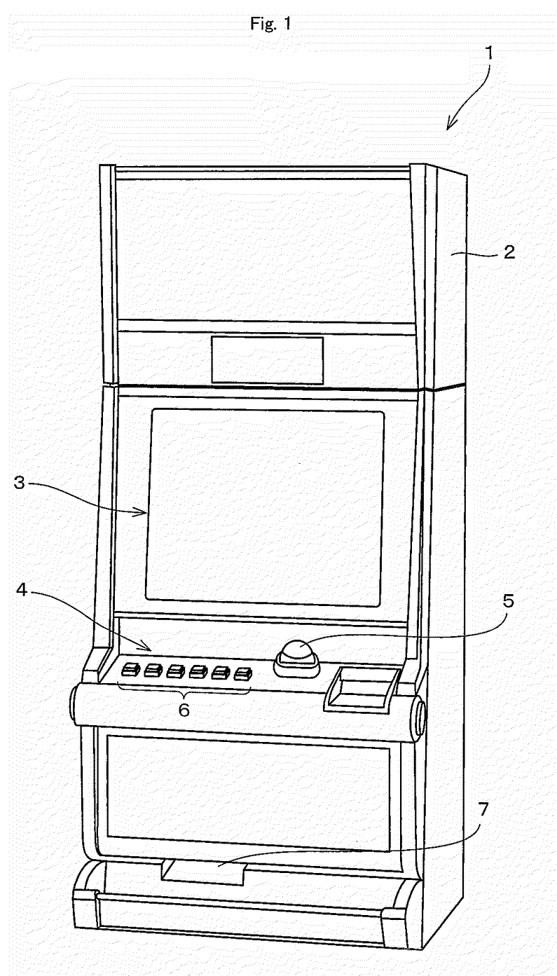

Hereinafter, a gaming machine according to an embodiment of the present invention will be described with reference to the drawings. FIG. 1 is an external view of a gaming machine according to an embodiment of the invention. The gaming machine 1 is configured as a gaming machine of a slot machine type. As illustrated in FIG. 1, the gaming machine 1 has a chassis 2. On a front surface of the chassis 2, there is provided a display device 3. For example, a liquid crystal display device is applied as the display device 3.

A control panel 4 is provided below the display device 3. A slot 5 of coins and an operation device 6 are provided on the control panel 4. The operation device 6 includes operation members for performing various operations such as betting operation or the like. Also, a payout port 7 of the coins is provided below the control panel 4.

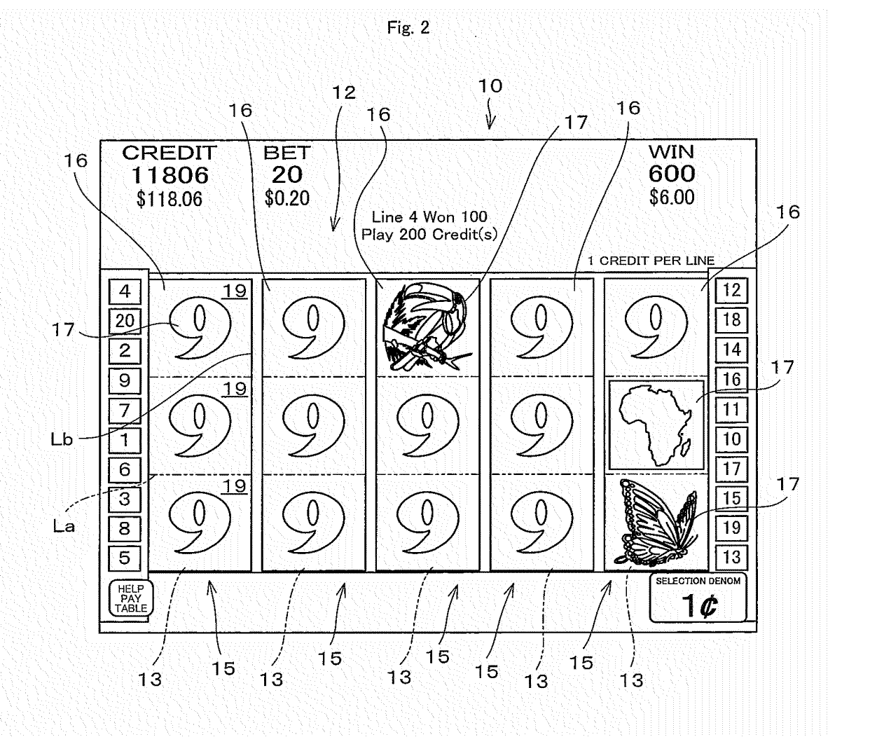

The display device 3 displays a game screen. FIG. 2 is a pattern diagram illustrating an example of the game screen. As illustrated in FIG. 2, the game screen 10 includes a lottery region 12 which serves as a predetermined region. In the lottery region 12, cells 13 are arranged in a predetermined arrangement (predetermined positional relationship). Specifically, as the predetermined arrangement, the cells 13 are located so as to be arranged in a matrix in longitudinal and transverse directions on a screen of the display device 3. In the example in FIG. 2, virtual lines La that separate the cells 13 arranged in the longitudinal direction are shown by the two-dot chain lines. In addition, in an actual game screen 10, the virtual lines La will not be displayed.

In contrast, the cells 13 arranged in the transverse direction are separated by separating lines Lb. In the example in FIG. 2, there are arranged 3 rows of the cells 13 in the longitudinal direction and 5 columns of the cells 13 in the transverse direction, in total 15 cells 13. One cell column 15 is configured by the cells 13 arranged linearly in the longitudinal direction. Accordingly, in the lottery region 12, five cell columns 15 are arranged so as to be parallel to each other in the transverse direction. In addition, the virtual lines La and the separating lines Lb in the FIG. 2, that is, the boundary lines for separating the cells 13 may be displayed according to an aspect where a player can visually recognize the lines, or may not be displayed.

The individual cell columns 15 correspond to five virtual reels 16. In the lottery region 12, there is displayed only a portion of each virtual reel 16 that overlaps the lottery region 12. The virtual reels 16 are configured by predetermined number of symbol regions 19 which are arranged in one direction. The total length of the virtual reel 16 is sufficiently longer than that of the cell column 15. The size of one symbol region 19 is the same as that of the cell 13.

In each symbol region 19 which is included in the virtual reel 16, any one of kinds of symbols 17 is fixedly disposed. As one example of the symbol 17, a numeral, a character, or a figure such as a bird, a butterfly, or a map is appropriately adopted. In addition, the number of symbol regions 19 that are included in the virtual reel 16 may be appropriately determined. Also, the arrangement of the symbols 17 in each of the five reels 16 may be the same with or be different from each other.

An arrangement direction of each cell 13 included in the cell column 15 in the lottery region 12 is matched with an arrangement direction of symbols 17 in the virtual reel 16. In the lottery region 16, one symbol 17 on the virtual reel 16 is displayed to be allocated to one cell 13. In addition, ideally, the virtual reel 16 is configured in a cylindrical shape, similar to a mechanical reel that symbols are arranged on an outer circumference of a cylindrical body.

If a game starts, the virtual reel 16 is scrolled from top to the bottom along the sell column 15. The scrolling is performed so as to virtually represent the movement of the symbols when a physical reel rotates by replacing the movement by image display. At predetermined stop time, each virtual reel 16 stops so that one symbol 17 appears in one cell 13. That is, a stop position of the scroll of the virtual reel 16 (which may be simply called a stop position of the virtual reel 16) is controlled in one cell unit.

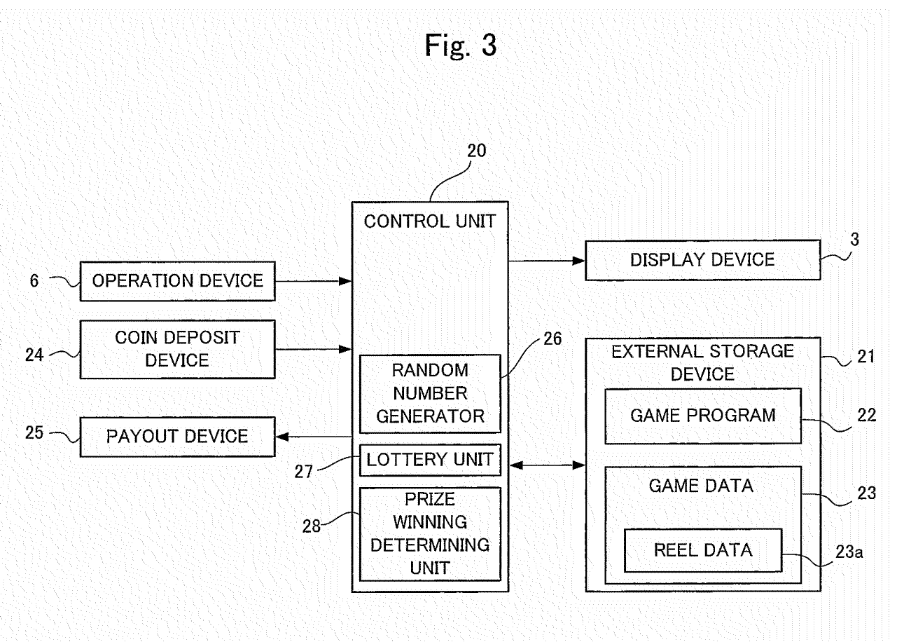

The configuration of the gemming machine 1 will be further described with reference to the FIG. 3. FIG. 3 is a functional block diagram of the gaming machine. As illustrated in FIG. 3, a control unit 20 is provided inside the chassis 2 of the gaming machine 1. The control unit 20 is configured as a computer unit including a microprocessor and other peripheral devices, such as a main storage device needed for the operation thereof and the like. An external storage device 21 is connected to the control unit 20.

As the external storage device 21, there is used a storage medium which is capable of holding storage without feeding of power, for example, an optical storage medium such as a DVD-ROM and a CD-ROM, or a nonvolatile semi conductor memory device such as an EEPROM.

The external storage device 21 stores a game program 22 and a game data 23. The game program 22 is a program that is needed to cause the gemming machine 1 to execute a game. The game data 23 is various kinds of data that is utilized when the game program 22 is executed. The game program 22 is appropriately read and is executed by the control unit 20. Also, the game date 23 is appropriately read and is referred by the control unit 20.

The game data 23 includes Reel data 23a. The reel data 23a is data that describes kinds of the symbols 17 in each symbol region 19 of the virtual reel 16. In addition, the game program 22 includes various kinds of program modules which are needed to cause the gaming machine 1 to execute the game, however they are not illustrated in the drawings. Similarly, the game data 23 includes other various kinds of data such as sound effect data, pay out data, or the like, however they are not illustrated in the drawings.

The operation device 6 and the display device 3 which are described above are connected to the control unit 20. The operation device outputs a signal according to an operation of the player to the control unit 20. The display device 3 displays an image according to an image signal which is output from the control unit 20. The control unit 20 executes a game in a predetermined sequence according to the game program 22 with referring to the output signal of the operation device 6. In accordance with this, the control unit 20 displays a game screen according to a progress condition of the game on the display device 3. For example, this game screen includes an image indicating the lottery region 12 and an image of a potion of the virtual reel 16 to be displayed in the lottery region 12 (that is, the symbol 17 to be displayed in each cell 13).

As an input device or an output device that is needed to execute the game, a coin deposit device 24 and a payout device 25 are further connected to the control unit 20. The coin deposit device 24 receives a deposit of coins as a value for playing a game through the slot 5 of coins. And, the coin deposit device 24 outputs a signal according to a deposit amount of coins to the control unit 20.

The payout device 25 executes a payment of coins as a dividend of the game to the player according to an instruction from the control unit20. The payment of coins is executed through the payout port 7. In addition, receiving the value for playing the game and the dividend to the player are not limited to coins. For example, as alternative currency, medals, tokens or the like may be used. Also, a settlement method that enables an exchange of a game value (including a currency value) through an exchange of electronic information such as an electronic currency or the like may be used. In this case, an information communication device that exchanges the electronic information mutually, a storage medium that stores information which is exchanged, or the like may be used instead of the slot 5 of coins and the payout port 7.

In the control unit 20, there are provided a random number generator 26, a lottery unit 27, and a prize winning determining unit 28. The random number generator 26 generates random numbers of a predetermined digit numbers. The random number generator 26 is a logical device that is realized by a combination of a microprocessor and software. In addition, the random number generator 26 may be a physical device where is combined with electronic circuits.

The lottery unit 27 acquires random numbers from the random number generator 26 and chooses the stop position of the virtual reel 16. The prize winning determining unit 28 determines whether or not the prize winning is present, when the virtual reels 16 are stopped. The lottery unit 27 and the prize winning determining unit 28 are logical devices that are realized by a combination of the microprocessor and the software. In the control unit 20, there are appropriately provided other logical devices or physical devices that are needed to execute a slot game, however they are not illustrated in the drawings.

Next, a procedure of a game which is executed in the gaming machine 1 will be described. In the gaming machine, if a signal, which indicates a deposit of the amount of coins needed for the game, is output from the coin deposit device 24 to the control unit20, the betting operation through the operation device 6 is enabled. And, a prize winning determination line according to an amount of betting is set on the lottery region 12 by the betting operation.

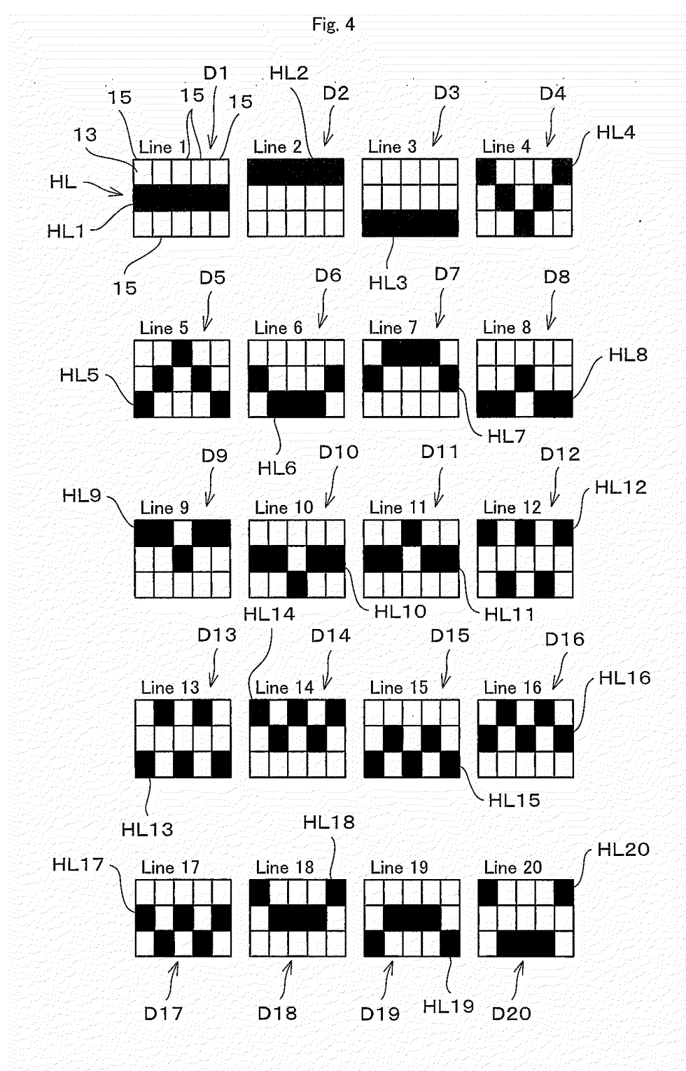

FIG. 4 is a diagram for describing the prize winning determination lines. D1 to D20 of the FIG. 4 indicate schematically the cell columns 15 in the lottery region 12 which is included in a game screen. The prize winning determination line HL is a virtual line that connects group of the plural cells 13 to become targets of determining whether or not the prize winning is present. In FIG. 4, the prize winning determination lines HL are illustrated by black cells. And, the D1 to the D20 correspond to the 1st prize winning determination line HL1 to the 20th prize winning determination line HL20. Specifically, each of D1 to D20 indicates each of the 1st prize winning determination line HL1 to the 20th prize winning determination line HL20 in such a manner that D1 corresponds to the 1st prize winning determination line HL1, D2 corresponds to the 2nd prize winning determination line HL2, and like this. As illustrated in the FIG. 4, twenty prize winning determination lines HL can be set on the lottery region 12.

Specifically, at first, the 1st prize winning determination line HL1 is set by betting of a minimum unit (one unit). Then, the prize winning determination line HL can be set in order of the 2nd prize winning determination line HL2, the 3rd prize winning determination line HL3 . . . until the 20th prize winning determination line HL20 whenever the betting amount increases by a predetermined unit. In addition, the prize winning determination line HL which is set whenever the betting amount increases by a predetermined unit is not limited to an embodiment that the prize winning determination line HL is added in predetermined order. For example, the prize winning determination line HL which is set whenever the betting amount increases by a predetermined unit may be instructed by the player. Also, the coin amount which corresponds to the one unit may be preliminarily set, or may be arbitrarily set by instruction of the player. For example, when the one unit is set to two coins, the prize winning determination line HL may be added for every additional two coins. Also, in this case, the minimum unit of the betting amount means two coins. Further, the plural prize winning determination lines may be set every betting of one unit. Also, a number of the prize winning determination lines which is set every betting of one unit may increase with increasing betting amount.

The prize winning determination line HL is used to determine a normal prize winning. In this case, the normal prize winning means that predetermined prize winning arrangement is formed on the prize winning determination line HL. For example, the prize winning arrangement is formed when three same symbols 17 are continuously arranged. The determination of the normal prize winning is executed for every the 1st prize winning determination line HL1 to the 20th prize winning determination line HL20. Accordingly, probability of the normal prize winning rises with increasing betting amount (the predetermined unit). A normal dividend which serves as an advantage of the prize winning is provided to the player with the normal prize winning. In addition, the prize winning arrangement is not limited to an embodiment that three same symbols 17 are continuously arranged. The prize winning arrangement may be formed when predetermined numbers of same symbols 17 such as two, four or five are continuously arranged. Further, a state that a predetermined number of same symbols 17 exist discontinuously on the prize winning determination line may be applied as the prize winning arrangement.

In contrast, if a signal instructing to start the game is output from the operation device 6 in a state where at least the minimum unit is bet (in a state where at least the 1st prize winning determination line HL1 is set), the control unit 20 determines that one game opportunity as a predetermined range has been generated. If the control unit 20 determined lake this, the control unit 20 executes a slot game routine. As a result, a slot game using the virtual reels 16 is played on the gaming machine 1. Details of the slot game routine will be described below.

In the one game opportunity, there is determined whether or not a special prize winning is present, in addition to described above determining whether or not the normal prize winning is present. Specifically, in the one game opportunity, the special prize winning is formed when a number of the prize winning determination lines HL winning the normal prize winning is equal to or more then a predetermined number of lines. When the special prize winning is formed, in addition to the normal dividend, a special advantage which serves as a favorable condition is provided. Specifically, ten lines are applied as the predetermined number of lines. And, when the number of the prize winning determination lines HL winning the normal prize winning is equal to or more than ten lines, the special prize winning is formed. In this case, as the special advantage, there is provided the special dividend according to a number of the prize winning determination lines HL on which the normal prize winning is formed. In the case of the number of the prize winning determination lines HL winning the normal prize winning is larger, the special dividend is bigger. That is, if the betting amount is greater, the probability of the special prize winning becomes higher and the probability to obtain the big special dividend when the special prize winning is formed also becomes higher.

In the example of the FIG. 2, there is illustrated in a case that the prize winning is won if the three same symbols are continuously arranged. In this case, if the FIG. 4 is referred, the prize winning arrangement is formed on the 1st prize winning determination line HL1, the 3rd prize winning determination line HL3, the 4th prize winning determination line HL4, the 6th prize winning determination line HL6, the 8th prize winning determination line HL8, the 9th prize winning determination line HL9, the 10th prize winning determination line HL10, the 13th prize winning determination line HL13, the 15th prize winning determination line HL15, the 16th prize winning determination line HL16, the 17th prize winning determination line HL17, the 18th prize winning determination line HL18, the 19th prize winning determination line HL19, the 20th prize winning determination line HL20. Accordingly, if the coins are bet for setting the 20th prize winning determination line HL20, the normal prize winning is won on a total of 14 prize winning determination lines HL. In this case, the normal dividends for 14 lines corresponding to a number of the normal prize winnings are provided to the player.

Further, in the example of the FIG. 2, if the prize winning determination line HL is set until the 16th prize winning determination line HL16, a number of the prize winnings reaches ten. Accordingly, if the coins are bet for setting the 16th prize winning determination line HL16 or more, the special prize winning is formed. In this case, in addition to the normal dividends corresponding to the number of lines on which the normal prize winning is formed, the special dividend is provided according to a number of lines exceeding ten lines. For example, if the coins are bet for setting the 20th prize winning determination line HL20, the number of the prize winning determination lines HL winning the normal prize winning reaches 14 lines. That is, it exceeds ten lines by five lines. In this case, the special dividend corresponding to five lines which exceed ten is provided. In contrast, if the betting amount of the coins is for setting the 15th prize winning determination line HL15, a number of the prize winning determination lines HL winning the normal prize winning does not reach ten. In this case, the normal dividends corresponding to the prize winnings for 9 lines are provided as the normal advantage, however the special dividend is not provided since the special prize winning is not won.

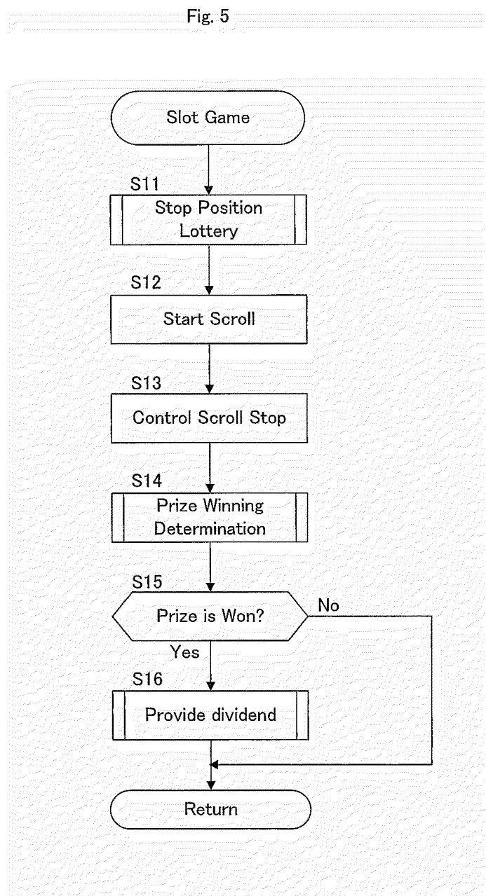

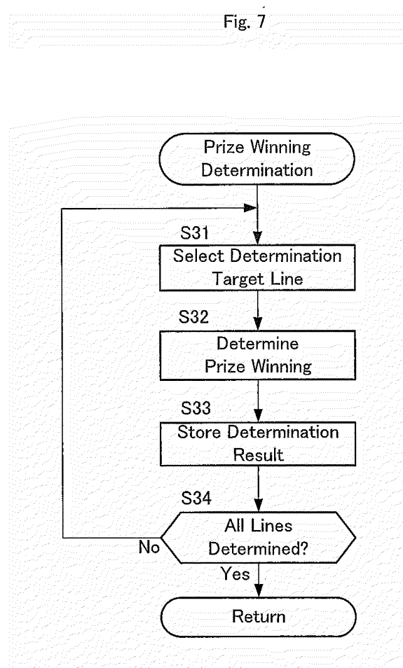

Next, the slot game routine which is executed by the control unit 20 will be described. FIG. 5 is a diagram illustrating an example of a flowchart of the slot game routine which is executed by the control unit 20. If a routine of the FIG. 7 is started, in step S11, the control unit 20 executes a subroutine that chooses the stop positions of the virtual reels 16. The contents of the subroutine will be described in detail below. Next, in step S12, the control unit 20 starts the scrolling of each virtual reel 16. Next, in step S13, the control unit 20 stops each virtual reel 16 at the stop position determined in step S11. Then, the control unit 20 proceeds to step S14 and executes a subroutine for the prize winning determination. The contents of the subroutine will be described below.

Next, in step S 15, the control unit 20 determines whether or not the prize winning is present, using the prize winning determining unit 28. Specifically, the control unit 20 determines whether or not the prize winning is present, using a processing result of the subroutine for the prize winning determination. When the result of the determination in the step S15 is negative, that is, when the control unit 20 determines that the prize winning is not won, the control unit 20 skips step S16 and terminates the slot game routine at this time.

On the other hand, when the result of the determination in the step S15 is positive, that is, when the control unit 20 determines that the prize winning is won, the control unit 20 proceeds to step S16. In step S16, the control unit 20 executes a subroutine for providing the dividend and terminates the slot game routine at this time. The contents of the subroutine for providing the dividend will be described below.

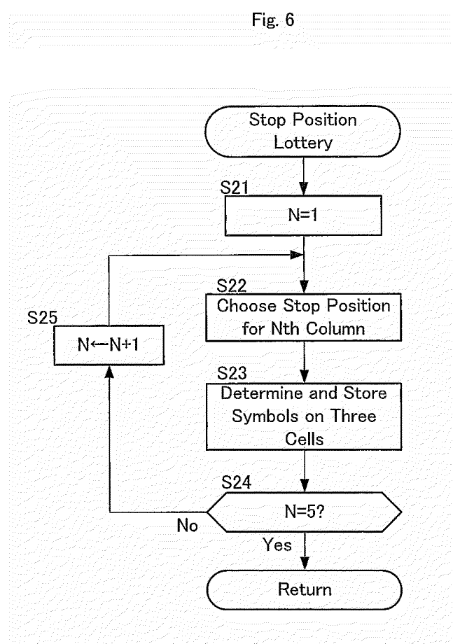

FIG. 6 is a diagram illustrating an example of a flowchart of a stop position lottery routine which is executed by the control unit 20. The subroutine of the FIG. 6 is called and executed in the routine of the FIG. 5, as a subroutine process with respect to the slot game routine. If the control unit 20 starts the stop position lottery routine of FIG. 6, first, in step S21, an initial value 1 is set to a variable N to specify a column number of the lottery target cell columns 15. In this case, for an example, a number which increases in order of 1, 2 . . . from the column 15 of the left end of the lottery region 12 is used as the column number.

Next, in step S22, the control unit 20 chooses the stop position of the virtual reel 16 in the lottery target cell column (N-th cell column) 15. The lottery is executed so that the lottery unit 27 acquires the random numbers from the random number generator 26. From the lottery result, a relationship between the symbol 17 and cell 13 where the symbols 17 is positioned in which the scroll of the virtual reel 16 needs to be stopped is determined. For example, in the virtual reel 16 of the FIG. 2, when a number is attached to each symbol region 19 from the upper end in the order of 1, 2, . . . , whether the scroll of the virtual reel 16 needs to be stopped when the symbol region 19 of any number is positioned at the cell 13 of the upper end of the cell column 15 can be determined according to the lottery result. If a number of the symbol regions 19 stopped in any cell 13 is determined, numbers of the symbol regions 19 that are stopped in another cells 13 in the same cell column 15 are also determined.

Next, the control unit 20 proceeds to step S23. In step S23, the control unit 20 determines the symbols 17 to be displayed on the three cells 13 which is included in the lottery target cell column 15, referring to the stop position of the virtual reel 16 chosen in step S22 and the arrangement of the symbol 17 specified by the reel data 23a. And, the control unit 20 stores the kinds of the symbols 17 to be displayed on the three cells 13 in the main storage device of the control unit 20. Then, the control unit 20 proceeds to step S24.

In step S24, the control unit 20 determines whether or not the variable N reaches 5. If the variable N does not reach 5 yet, the control unit 20 proceeds to step S25. In step S25, the control unit 20 adds 1 to the variable N, and then, returns to the process of the step S22. On the other hand, in step S24, if the variable N reaches 5, the control unit 20 terminates the stop position lottery routine, and returns to the routine of the FIG. 5. By executing the above described subroutine, all symbols 17 to be displayed on the cells 13 are determined, and stored.

FIG. 7 is a diagram illustrating an example of a flowchart of a prize winning determination routine which is executed by the control unit 20. The subroutine of the FIG. 7 is called and executed at step S14 in the routine of the FIG. 5, as a subroutine process with respect to the slot game routine. This process is executed using the prize winning determining unit 28.

If the control unit 20 starts the prize winning determination routine of the FIG. 7, first, in step S31, the control unit 20 selects any one of the prize winning determination lines HL which has been set on the lottery region 12. As described above, the prize winning determination line HL has been appropriately set according to the number of bets, the selection by the player, or the like. Next, in step S32, the control unit 20 determines whether or not the prize winning is present on the selected prize winning determination line HL. Specifically, the control unit 20 determines whether or not the symbols 17 form the prize winning arrangement in the five cells 13 which are positioned on the selected prize winning determination line HL.

Next, in step S33, the control unit 20 stores a result of the prize winning determination in step S32, and then, proceeds to step S34. In step S34, the control unit 20 determines whether or not the determination of the presence or absence of the prize winning is determined for all of prize winning determination lines HL which are set on the lottery region 12. When this result of the determination is negative, that is, when the non-determined prize winning determination line HL remains, the control unit 20 proceeds to step S31, and selects a new prize winning determination line HL. In addition, when only one prize winning determination line HL is set on the lottery region 12, the result of the determination of step S34 is always positive.

On the other hand, when the result of the determination of step S34 is positive, that is, when the determination of the presence or absence of the prize winning is determined for all of prize winning determination lines HL which are set on the lottery region 12, the control unit 20 terminates the prize winning determination routine at this time, and returns to the routine of the FIG. 5. Then, in step S15 of the FIG. 5, the presence or absence of the prize winning is determined based on the result of the determination which is stored in step S33 of the FIG. 7.

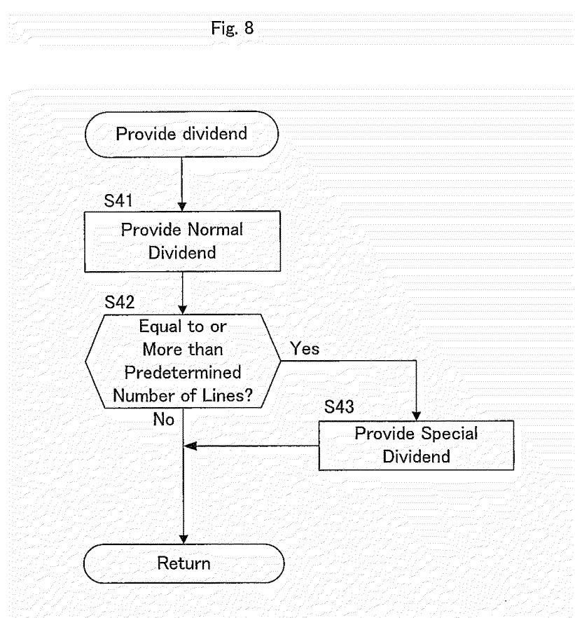

FIG. 8 is a diagram illustrating an example of a flowchart of a dividend providing routine which is executed by the control unit 20. The subroutine of the FIG. 8 is called and executed at step S16 in the routine of the FIG. 5, as a subroutine process with respect to the slot game routine.

If the control unit20 starts the dividend providing routine of the FIG. 8, first, in step S41, the control unit 20 provides a content of the prize winning, that is, the normal dividend every normal prize winnings according to the kinds of symbols 17 forming the prize winning arrangement to the player based on the result of the determination in the step S15 of the routine of the FIG. 5. The dividend is provided in form of a payout of coins or a right to play a game. The right to play the game is quantitatively expressed in a unit referred to as a credit. The value of the normal dividend is basically varied in relation to the probability of the prize winning arrangement being formed. Specifically, in the case of the prize winning arrangement where the probability of the prize winning arrangement being formed is low, the value of the normal dividend that corresponds to the formation is set high.

Next, in step S42, the control unit 20 determines whether or not a number of the prize winning determination lines HL winning the normal prize winning is equal to or more than the predetermined number of lines. For example, a number of ten is used as the predetermined number of lines. When this result of determination is negative, that is, when the number of the prize winning determination lines HL on which the normal prize winning is formed dose not reach the number of ten, the control unit 20 terminates the dividend providing routine at this time.

On the other hand, when the result of the determination of step S41, that is, when the number of the prize winning determination lines HL winning the normal prize winning is equal to or more than ten lines, the control unit 20 proceeds to step S43. In step S43, the control unit 20 provides the special dividend additionally. The special dividend is also provided in form of a payout of coins or a right to play the game. The value of the special dividend (for an example, an amount of the coins which is paid out) is varied in relation to the number of the prize winning determination lines HL on which the normal prize winning is formed, that is, in relation to the number of the prize winnings. Specifically, if the number of the prize winnings is larger, the value of the special dividend becomes high. The control unit 20 terminates the dividend providing routine at this time after providing the special dividend in step S44.

As described above, according to the gaming machine in this embodiment, the plural normal prize winnings can be generated in the one game opportunity. The probability of the normal prize winning rises with increasing betting amount (predetermined unit). And, if the number of the normal prize winnings which is generated in the one game opportunity exceeds the predetermined number of the prize winnings, the special prize winning can be generated additionally. Accordingly, the special dividend can be provided additionally, using the number of the normal prize winnings which is generated in the one game opportunity. Thus, since the number of the normal prize winnings can be used for a favorable condition of the game, an interest of the game can be improved.

Also, if the coins equal to or more than a certain unit are not bet, the special prize winning is not generated. And, the probability of the special prize winning rises with increasing betting amount, further, the special dividend when the special prize winning is won also increases with increasing betting amount. Accordingly, it is possible to prompt large amount of betting, that is, to prompt an increase of a consumed amount of the game value to the player.

In the above embodiment, the control unit 20 serves as the symbol lottery device by executing the stop position lottery routine of the FIG. 6, and serves as the prize winning determination device by executing the process of step S15 of FIG. 5 and the routine of the FIG. 7. Further, the control unit 20 serves as the prize winning advantage providing device by executing step S41, serves as the prize winning number determination device by executing step S42, and serves as the condition providing device by executing step S43 of the FIG. 8.

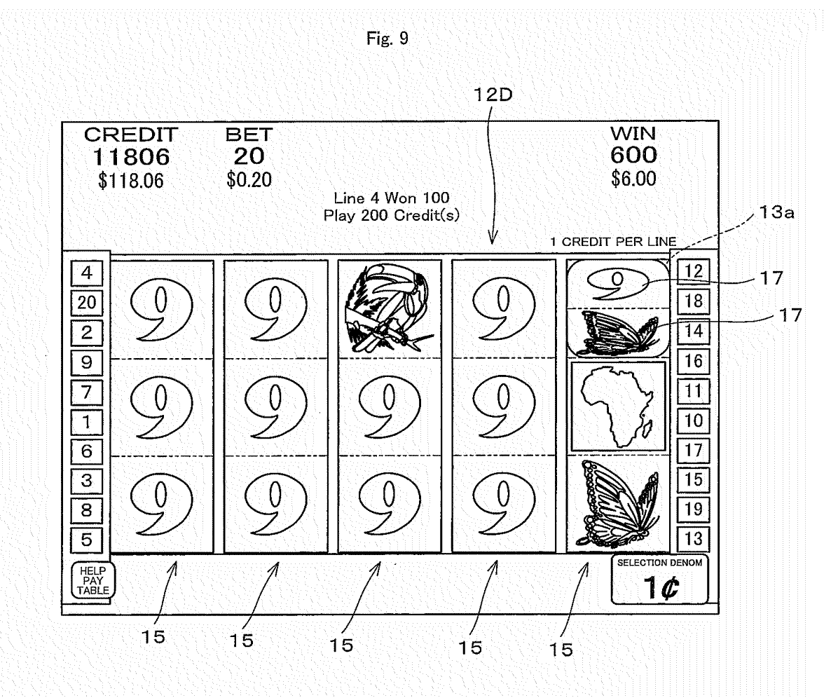

The present invention is not limited to the embodiment described above, and can be embodied in an appropriate form. In the embodiment described above, one symbol 17 is displayed on each cell 13 in the lottery region 12, however the lottery region 12 is not limited to the embodiment like this. The FIG. 9 is a diagram illustrating an example of the lottery region that two symbols are displayed on the one cell. As illustrated in the FIG. 9, the cell column 15 which is positioned at right end of the lottery region 12D includes the cell 13a that two symbols 17 are displayed at the position of the end of upper direction. Thus, the lottery region may include the cell that plural symbols are displayed. In this case, the cell that plural symbols are displayed may serve as the plural symbols. Since the cell like this relates to rise of the probability of the prize winning, the cell like this which serves as plural symbols may be displayed in the lottery region as an advantage or according to the betting amount.

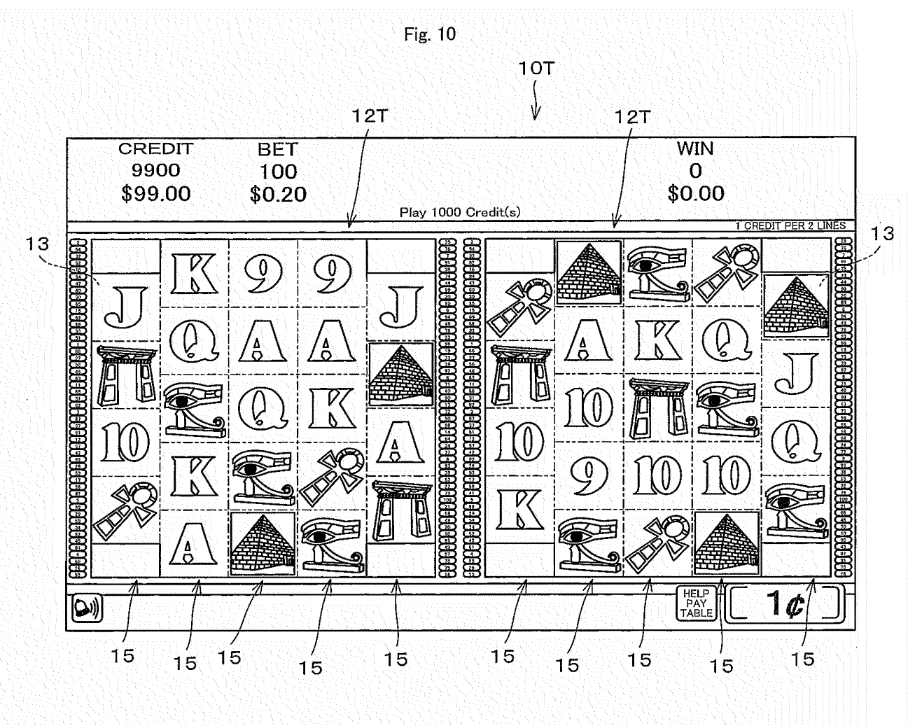

Also, in the embodiment described above, the game screen 10 includes one lottery region 12, however the game screen 10 is not limited to the embodiment like this. For example, the game screen may include plural lottery regions. FIG. 10 is a diagram illustrating another example of the game screen. As illustrated the FIG. 10, the game screen 10T includes two lottery regions 12T. In this case, a total number of the prize winnings which is included on the two lottery regions 12T may be used as the number of the prize winnings. Also, as illustrated the FIG. 10, the number of the cells 13 which is included in each cell column 15 may not be same between each cell 15. That is, any arrangement may be applied as the arrangement of the cells which constitute the lottery region if the prize winning arrangement can be formed.

In the embodiment described above, the one game opportunity is applied as the predetermined range, and the presence or absence of the special prize winning is determined based on the number of the prize winnings in the one game opportunity, however the predetermined range is not limited to the one game opportunity. For example, whether or not the special prize winning is present may be determined based on the number of the prize winnings in a predetermined number of times of the game such as two times, three times, or the like. In this case, it is possible to prompt an increase of the consumed amount of the game value in the predetermined number of times of the game since the number of the prize winnings in the predetermined number of times of the game can be used for condition of the game. Further, the predetermined range is not limited to the number of times of the game opportunity. For example, a certain time frame in the one game opportunity may be applied as the predetermined range. Also, as the predetermined range, there may be applied a predetermined time frame such as a time frame from predetermined start time to predetermined finish time, or while a personal authentication card is inserted in an authentication device etc.

In the embodiment described above, the gaming machine is configured as a so-called slot machine, however the gaming machine is not limited to the embodiment like this. For example, in the gaming machine, a bingo game may be played as the game opportunity. Further, the game opportunity which is played on the gaming machine is not limited to a game that the prize winning arrangement is formed. Also, the game opportunity is not limited to the embodiment that the probability of the prize winning rises with increasing betting amount of the game value consumed for the one game opportunity. And, the game opportunity is also not limited to the embodiment that the plural prize winnings are generated in one game opportunity. As the game opportunity, there may be applied any game opportunity which is capable to generate at least one prize winning.

Any kinds of types may be applied as the increasing pattern of a predetermined amount of the game value which is provided as the special dividend. For example, a type of addition which adds the game value every increase of the number of the prize winnings such as +1, +2, or the like may be applied as the increasing pattern of the predetermined amount of the game value. Also, a type of multiple which increase in multiple such as double, triple, or the like may be applied. And, a type of exponential which increase in exponential every increasing of a certain number (for example five) of the prize winnings such as double, quadruple, or the like may be applied.

Also, the advantage of the special prize winning is not limited to the special dividend. For example, a predetermined number of free games (this can be played without consumption of the game value) according to the number of the prize winnings may be provided as the advantage of the special prize winning. A progressive game which has high probability of the prize winning may be provided as the advantage of the special prize winning. In this case, the probability of a prize winning in the progressive game may rise according to the number of the prize winnings, or a dividend when a prize winning is generated in the progressive game may rise according to the number of the prize winnings. That is, any favorable condition may be provided to the player who wins the special prize winning.

In the embodiment described above, the game opportunity is provided at one time with the consumption of the game value equal to or more than the one unit, and, in the game opportunity like this, there is executed the determination of the special prize winning, that is, the determining whether or not the number of the prize winnings is equal to or more than the predetermined number. However, the determining whether or not the number of the prize winnings is equal to or more than the predetermined number is not limited to the embodiment that the determination is executed in the game opportunity like this. For example, the determining whether or not the number of the prize winnings is equal to or more than the predetermined number may be executed in the free game. And, the free game may be provided as the advantage of the normal prize winning or the like. In the case like this, it is possible to improve an expectation of the free game which is provided with the normal prize winning. Accordingly, in this case, it is also possible to use the number of the prize winnings for the motivation for the game opportunity.

What is claimed is:

1. A gaming machine providing a game opportunity in which at least one prize winning can be generated, the gamming machine comprising:
a prize winning determination device that determines whether or not the prize winning is present in the game opportunity;
a prize winning advantage providing device that provides prize winning advantage when the prize winning is generated based on a result of determination by the prize winning determination device;
a prize winning number determination device that determines whether or not a number of prize winnings in a predetermined range is equal to or more than a predetermined number of the prize winnings based on a result of the determination by the prize winning determination device; and
a condition providing device that provides favorable condition when the number of the prize winnings is equal to or more than the predetermined number of the prize winnings based on a result of the determination by the prize winning number determination device.

2. The gaming machine according to claim 1, wherein the game opportunity is provided at one time in exchange of consumption of a game value more than or equal to one unit, and,
a probability of the prize winning rises with increasing number of the units of the game value which is consumed for one game opportunity.

3. The gaming machine according to claim 2, wherein a number of times of the game opportunity is used as the predetermined range, and
the prize winning number determination device determines whether or not the number of the prize winnings generated in a predetermined number of times of the game opportunity is equal to or more than the predetermined number of the prize winnings.

4. The gaming machine according to claim 3, wherein a game opportunity in which plural prize winnings can be generated is provided as the one game opportunity, and
the prize winning number determination device applies one time as the predetermined number of times, and determines whether or not the number of the prize winnings generated in the one game opportunity is equal to or more than the predetermined number of the prize winnings.

5. The gaming machine according to claim 1, wherein the favorable condition is set so that the favorable condition becomes better with increasing number of the prize winnings.

6. The gaming machine according to claim 1, wherein the condition providing device provides a game value as the favorable condition.

7. The gaming machine according to claim 4, wherein the condition providing device provides a game value as the favorable condition.

8. The gaming machine according to claim 6, wherein the condition providing device provides the game value so that an amount of the game value increases with increasing number of the prize winnings.

9. The gaming machine according to claim 7, wherein the condition providing device provides the game value so that an amount of the game value increases with increasing number of the prize winnings.

10. The gaming machine according to claim 1, further comprising;
a display device that displays a game screen; and
a symbol lottery device that chooses each kind of symbols to be arranged in a predetermined positional relationship in a predetermined region of the game screen, wherein a game opportunity that generates the prize winning when a predetermined prize winning arrangement is formed by the symbols in the predetermined region based on a result of the lottery by the symbol lottery device is provided as the game opportunity.

11. The gaming machine according to claim 4, further comprising;
a display device that displays a game screen; and
a symbol lottery device that chooses each kind of symbols to be arranged in a predetermined positional relationship in a predetermined region of the game screen, wherein a game opportunity that generates the prize winning when a predetermined prize winning arrangement is formed by the symbols in the predetermined region based on a result of the lottery by the symbol lottery device is provided as the game opportunity.

12. The gaming machine according to claim 5, further comprising;
a display device that displays a game screen; and
a symbol lottery device that chooses each kind of symbols to be arranged in a predetermined positional relationship in a predetermined region of the game screen, wherein a game opportunity that generates the prize winning when a predetermined prize winning arrangement is formed by the symbols in the predetermined region based on a result of the lottery by the symbol lottery device is provided as the game opportunity.

13. The gaming machine according to claim 6, further comprising;
a display device that displays a game screen; and
a symbol lottery device that chooses each kind of symbols to be arranged in a predetermined positional relationship in a predetermined region of the game screen, wherein a game opportunity that generates the prize winning when a predetermined prize winning arrangement is formed by the symbols in the predetermined region based on a result of the lottery by the symbol lottery device is provided as the game opportunity.

14. The gaming machine according to claim 13, wherein the favorable condition is set so that the favorable condition becomes better with increasing number of the prize winnings.

15. The gaming machine according to claim 7, further comprising;
a display device that displays a game screen; and
a symbol lottery device that chooses each kind of symbols to be arranged in a predetermined positional relationship in a predetermined region of the game screen, wherein a game opportunity that generates the prize winning when a predetermined prize winning arrangement is formed by the symbols in the predetermined region based on a result of the lottery by the symbol lottery device is provided as the game opportunity.

16. The gaming machine according to claim 8, further comprising;
a display device that displays a game screen; and
a symbol lottery device that chooses each kind of symbols to be arranged in a predetermined positional relationship in a predetermined region of the game screen, wherein a game opportunity that generates the prize winning when a predetermined prize winning arrangement is formed by the symbols in the predetermined region based on a result of the lottery by the symbol lottery device is provided as the game opportunity.

17. The gaming machine according to claim 9, further comprising;
a display device that displays a game screen; and
a symbol lottery device that chooses each kind of symbols to be arranged in a predetermined positional relationship in a predetermined region of the game screen, wherein a game opportunity that generates the prize winning when a predetermined prize winning arrangement is formed by the symbols in the predetermined region based on a result of the lottery by the symbol lottery device is provided as the game opportunity.

18. The gaming machine according to claim 17, wherein the favorable condition is set so that the favorable condition becomes better with increasing number of the prize winnings.

19. A method of controlling a computer which is incorporated into a gaming machine providing a game opportunity in which at least one prize winning can be generated, including the steps:
a prize winning determination step that determines whether or not the prize winning is present in the game opportunity;
a prize winning advantage providing step that provides prize winning advantage when the prize winning is generated based on a result of determination by the prize winning determination step;
a prize winning number determination step that determines whether or not a number of prize winnings in a predetermined range is equal to or more than a predetermined number of the prize winnings based on a result of the determination by the prize winning determination step; and
a condition providing step that provides favorable condition when the number of the prize winnings is equal to or more than the predetermined number of the prize winnings based on a result of the determination by the prize winning number determination step.

20. A storage medium storing a computer program for a gaming machine being configured to make a computer, which is incorporated into the gaming machine providing a game opportunity in which at least one prize winning can be generated, serve as:
a prize winning determination device that determines whether or not the prize winning is present in the game opportunity;
a prize winning advantage providing device that provides prize winning advantage when the prize winning is generated based on a result of determination by the prize winning determination device;
a prize winning number determination device that determines whether or not a number of prize winnings in a predetermined range is equal to or more than a predetermined number of the prize winnings based on a result of the determination by the prize winning determination device; and
a condition providing device that provides favorable condition when the number of the prize winnings is equal to or more than the predetermined number of the prize winnings based on a result of the determination by the prize winning number determination device.
